(19) United States
(12) Patent Application Publication
(10) Pub. No.: US 2017/0343284 A1
(43) Pub. Date: Nov. 30, 2017

(54) Heat Pump System And Drier Or Washer-Drier Having The Same

(71) Applicant: Wuxi Little Swan Co., Ltd., Wuxi (CN)

(72) Inventors: Yulai MIAO, Wuxi (CN); Song LU, Wuxi (CN); Wei QIAN, Wuxi (CN)

(21) Appl. No.: 15/417,614

(22) Filed: Jan. 27, 2017

(30) Foreign Application Priority Data
May 31, 2016 (CN) 201610379014.8
May 31, 2016 (CN) 201620517477.1

(51) Int. Cl. F26B 23/00; F25B 30/02

(52) U.S. Cl. CPC F26B 23/004; F25B 30/02; F25B 2500/13

(57) ABSTRACT

A heat pump system, and a drier or washer-drier having the same are provided. The heat pump system includes a base, a horizontal compressor and a damper, in which the horizontal compressor is mounted to the base; the damper is supported on the base and supports the horizontal compressor; at least two dampers are arranged along an axial direction of the horizontal compressor. According to the present invention, vibration and noise of the heat pump system may be reduced effectively, and the overall service life thereof may be improved.

### CROSS-REFERENCE TO RELATED APPLICATION

This application claims priority to and benefits of Chinese Patent Application Serial No. 201610379014.8, filed with the State Intellectual Property Office of P. R. China on May 31, 2016, and Chinese Patent Application Serial No. 201620517477.1, filed with the State Intellectual Property Office of P. R. China on May 31, 2016. The entire contents of each of the afore-mentioned patent applications are incorporated herein by reference.

### FIELD

The present invention relates to a field of household appliances, and more particularly to a heat pump system, and a drier or washer-drier having the same.

### BACKGROUND

A drum-type washer-drier may adopt various drying modes, including heat pump drying. In the related art, a heat pump drying system of a heat pump washer-drier is often installed in a separated manner. That is, a compressor and two other devices are disposed at upper and lower parts of the washing machine separately, and connected via pipes, which complicates the structure and is not conductive to production and maintenance.

In the related art, various components of the heat pump drying system are integrated, but high-frequency vibration will be produced during operation of the compressor, and transmitted to other components via contact surfaces, which negatively affects user experience and component service life.

### SUMMARY

The present invention aims to solve at least one of the problems existing in the related art. Thus, embodiments of the present invention provide a heat pump system that may reduce and absorb vibration produced by a horizontal compressor.

Embodiments of the present invention further provide a drier or washer-drier having the heat pump system.

According to embodiments of a first aspect of the present invention, the heat pump system includes a base; a horizontal compressor mounted to the base; and a damper supported on the base and supporting the horizontal compressor, at least two dampers being arranged along an axial direction of the horizontal compressor.

For the heat pump system according to the present invention, vibration and noise may be reduced effectively, and the overall service life may be improved, by providing a plurality of dampers to support the horizontal compressor.

In some embodiments, the damper includes a first damper provided with a damping convex rib abutting against the base and the horizontal compressor, and the first damper is provided with one damping convex rib or a plurality of spaced damping convex ribs.

Further, the damping convex rib has a hollow or solid elongated shape extending along the axial direction of the horizontal compressor, and the plurality of spaced damping convex ribs are arranged in a direction surrounding the horizontal compressor.

Preferably, the first damper fitted over an outer circumferential surface of the horizontal compressor has an annular shape, and extends along the axial direction of the horizontal compressor.

In some embodiments of the present invention, the first damper further includes an end plate in perpendicular to the axial of the horizontal compressor, and the end plate abuts against an end face of the horizontal compressor.

Preferably, two first dampers are provided and fitted over two ends of the horizontal compressor respectively.

In some embodiments of the present invention, the damper includes a second damper disposed to the base and supporting a bottom of the horizontal compressor, and the second damper has a hollow or solid structure, and an upper surface configured as an arc surface matching part of an outer surface of the horizontal compressor.

Preferably, a ventilation hole is formed in a surface of the second damper abutting against the horizontal compressor, and runs through the second damper to be in communication with exterior space.

Advantageously, the second damper includes a substrate and a supporting part, the substrate is disposed to the base, the supporting part is disposed on the substrate and supports the horizontal compressor, and the supporting part has a size smaller than the substrate in the axial direction of the horizontal compressor.

Alternatively, the second damper supports a middle part of the horizontal compressor along the axial direction of the horizontal compressor.

According to embodiments of a second aspect of the present invention, the drier or washer-drier includes the heat pump system according to the embodiments of the first aspect of the present invention.

The drier or washer-drier according to the present invention enjoys a higher overall performance by providing the heat pump system according to the first aspect of the present invention.

Additional aspects and advantages of embodiments of present invention will be given in part in the following descriptions, become apparent in part from the following descriptions, or be learned from the practice of the embodiments of the present invention.

### BRIEF DESCRIPTION OF THE DRAWINGS

FIG. 1 is a schematic view of a heat pump system according to an embodiment of the present invention;

FIG. 2 is a sectional view of the heat pump system in FIG. 1;

FIG. 3 is an exploded view of the heat pump system in FIG. 1;

FIG. 4 is an exploded view of the heat pump system in FIG. 1 from another angle;

FIG. 5 is a schematic view of a first damper mounted at a left side of a horizontal compressor in FIG. 4;

FIG. 6 is a schematic view of the first damper in FIG. 5 from another angle;

FIG. 7 is a schematic view of the first damper in FIG. 5 from another angle;

FIG. 8 is a schematic view of a first damper mounted at a right side of the horizontal compressor in FIG. 4;

FIG. 9 is a schematic view of the first damper in FIG. 8 from another angle;

FIG. 10 is a schematic view of the first damper in FIG. 8 from another angle;

FIG. 11 is a schematic view of a second damper in FIG. 4;

FIG. 12 is a schematic view of the second damper in FIG. 11 from another angle;

FIG. 13 is an exploded view of the heat pump system according to the embodiment of the present invention.

### REFERENCE NUMERALS

heat pump system 100,
base 1,
horizontal compressor 2,
first damper 31, damping convex rib 311, end plate 312, processing hole 313,
second damper 32, substrate 321, supporting part 322, ventilation hole 323,
condenser 4, evaporator 5, throttling device 6, top cover 7, filtering device 8.

### DETAILED DESCRIPTION

Embodiments of the present invention will be described in detail and examples of the embodiments will be illustrated in the drawings, where same or similar reference numerals are used to indicate same or similar members or members with same or similar functions. The embodiments described herein with reference to drawings are explanatory, which are used to illustrate the present invention, but shall not be construed to limit the present invention.

Various embodiments and examples are provided in the following description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

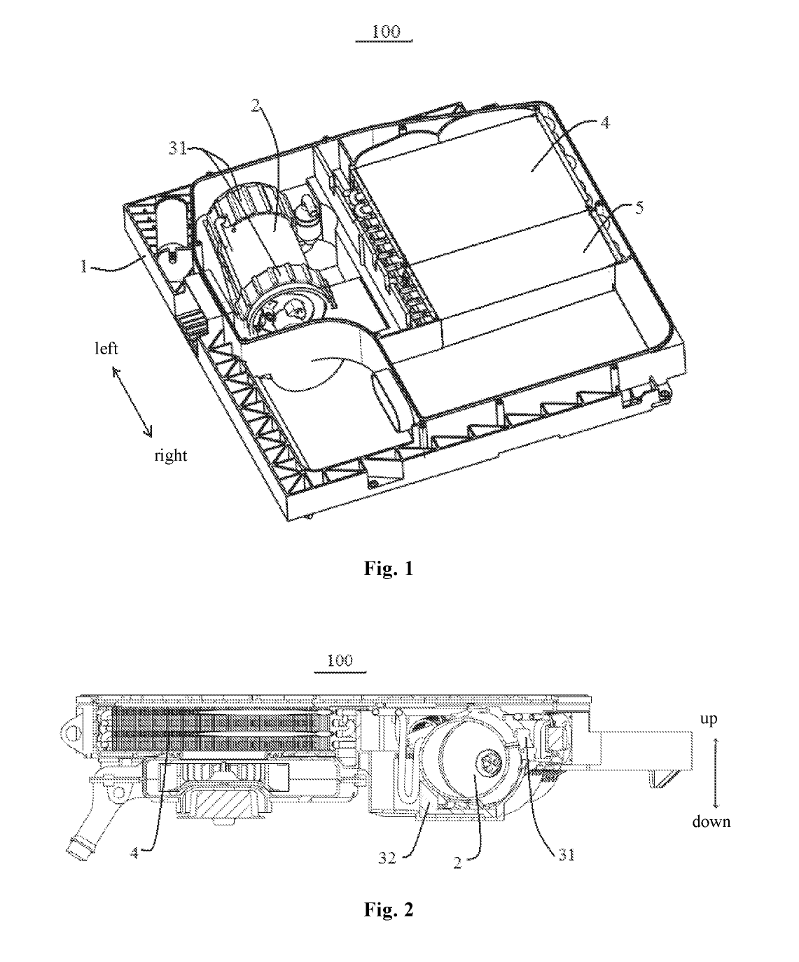

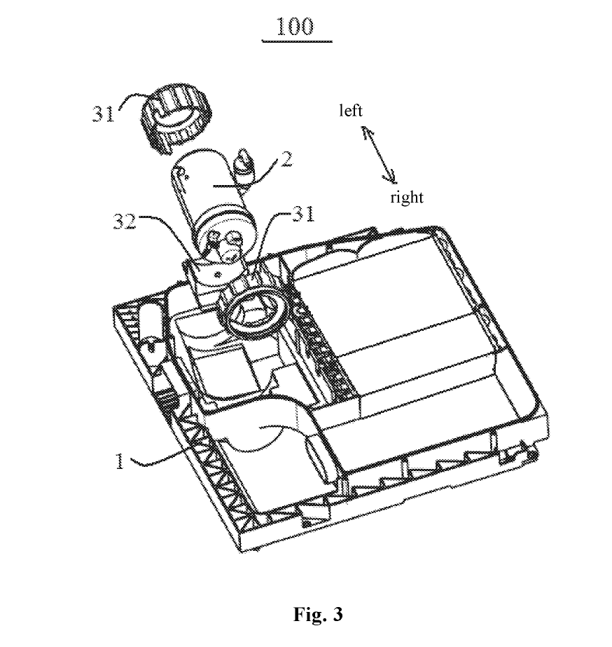

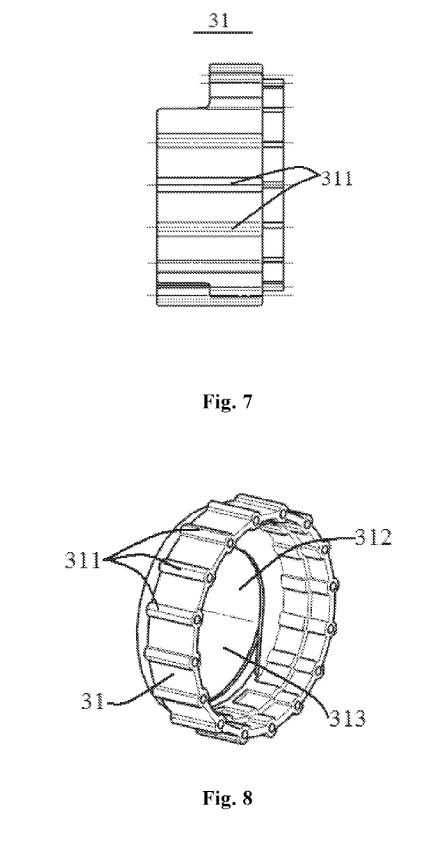

In the following, a heat pump system 100 according to embodiments of a first aspect of the present invention will be described with reference to FIGS. 1 to 13.

As shown in FIG. 1, the heat pump system 100 includes a base 1, a horizontal compressor 2, and a damper (e.g. a first damper 31 and a second damper 32 shown in FIG. 1).

Specifically, the horizontal compressor 2 is mounted to the base 1; the damper is supported on the base 1 and supports the horizontal compressor 2, and at least two dampers, i.e. two, three, four or more, may be provided and arranged along an axial direction (e.g. a left-and-right direction in FIG. 1) of the horizontal compressor 2, so as to guarantee a damping effect of the damper on the horizontal compressor 2.

During operation of the heat pump system 100, the horizontal compressor 2 will produce high-frequency vibration due to its rotation. In this application, the damper is provided to support the horizontal compressor 2, that is, the base 1 and the horizontal compressor 2 are connected through the damper rather than contact with each other directly, and the damper may serve as a cushion to reduce the vibration transmitted to the base 1 and other components mounted in the base 1, so as to reduce the vibration and noise effectively and prolong the service life of components.

For the heat pump system 100 according to the present invention, the vibration and noise may be reduced effectively, and the overall service life may be extended, by providing a plurality of dampers to support the horizontal compressor 2.

In an embodiment of the present invention, as shown in FIGS. 1, 4 and 5, the damper may include the first damper 31 provided with a damping convex rib 311 abutting against the base 1 and the horizontal compressor 2. That is, the base 1 and the horizontal compressor 2 are connected through the damping convex rib 311, such that the damping convex rib 311 may reduce a contact area of the first damper 31 with the base 1 and the horizontal compressor 2, so as to further reduce the vibration of the horizontal compressor 2 and lower the noise. Preferably, the first damper may be provided with one damping convex rib 311 or a plurality of spaced damping convex ribs 311, so as to improve flexibility of arranging the damping convex rib 311. In addition, if the plurality of spaced damping convex ribs 311 is provided, the reliability of supporting the horizontal compressor 2 by the damper may be improved to guarantee the damping effect of the damper.

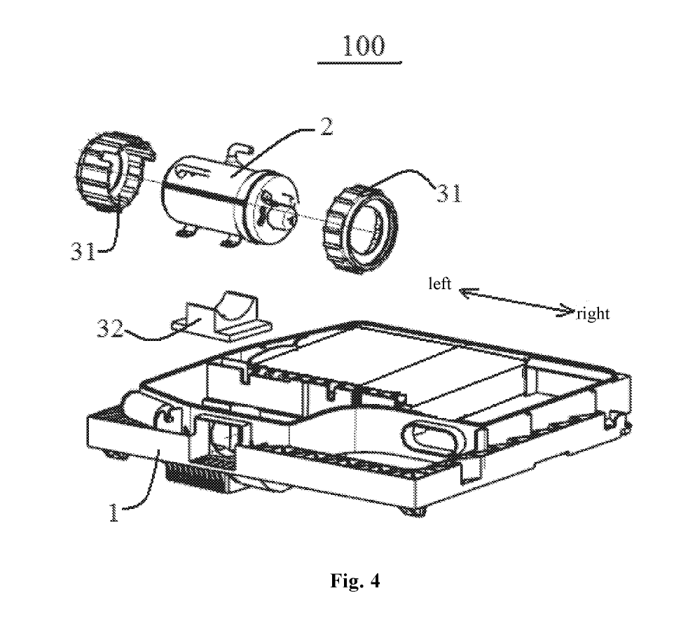

Further, as shown in FIGS. 4 to 6, the damping convex rib 311 may have a hollow or solid elongated shape extending along the axial direction (e.g. a left-and-right direction in FIG. 4) of the horizontal compressor 2, and the plurality of spaced damping convex ribs 311 are provided and arranged in a direction surrounding the horizontal compressor 2. Thus, it is possible to further improve the damping effect of the first damper 31 and make the structure of the first damper 31 more reasonable.

Preferably, as shown in FIGS. 1 and 4, the first damper 31 may have an annular shape fitted over an outer circumferential surface of the horizontal compressor 2, and extend along the axial of the horizontal compressor 2, so as to increase a range of wrapping the horizontal compressor 2 and improve the damping effect on the horizontal compressor 2; meanwhile, it is convenient to mount the first damper 31, resulting in a higher assembling efficiency, and the structure of the first damper 31 becomes more reasonable.

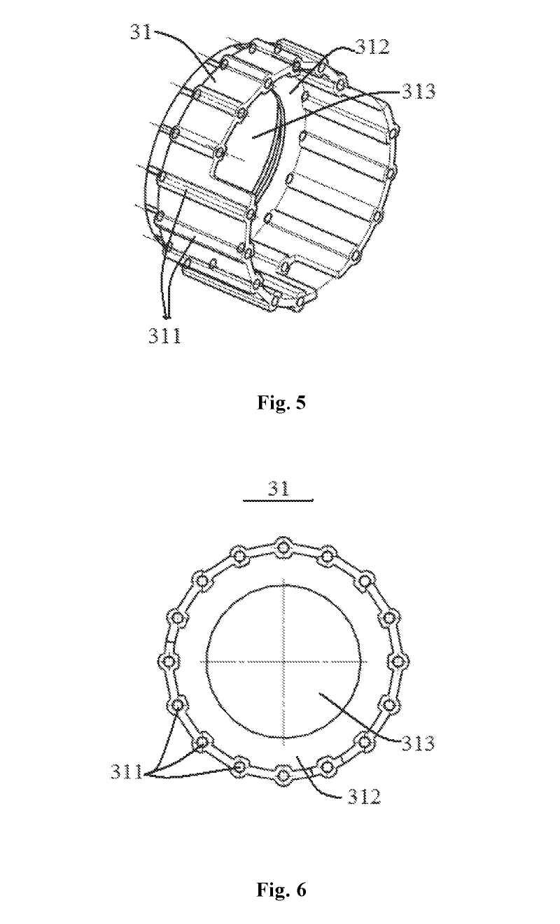

In some embodiments of the present invention, as shown in FIGS. 5 and 6, the first damper 31 may further include an end plate 312 in perpendicular to the axial of the horizontal compressor 2, and the end plate 312 abuts against an end face of the horizontal compressor 2, such that the end plate 312 can serve to position the first damper 31 and prevent the first damper 31 from sliding along the axial direction of the horizontal compressor 2, thereby improving the reliability and stability of assembling the first damper 31 and the horizontal compressor 2.

Preferably, as shown in FIG. 4, two first dampers 31 may be provided and fitted over two ends (e.g. a left end and a right end of the horizontal compressor 2 in FIG. 4) of the horizontal compressor 2 respectively. Consequently, one first damper 31 is fitted over each of the two axial ends of the horizontal compressor 2, which may improve the stability of supporting the horizontal compressor 2 effectively and further reduce the vibration and noise of the horizontal compressor 2.

In some embodiments of the present invention, as shown in FIGS. 4, 11 and 12, the damper may include the second damper 32 disposed in the base 1 and supporting a bottom of the horizontal compressor 2, and the second damper 32 has a hollow or solid structure, and an upper surface configured as an arc surface matching part of an outer surface of the horizontal compressor 2. Thus, the second damper 32 may generate the damping effect at the same time of supporting the horizontal compressor 2, and hence the structure of the second damper 32 becomes more reasonable.

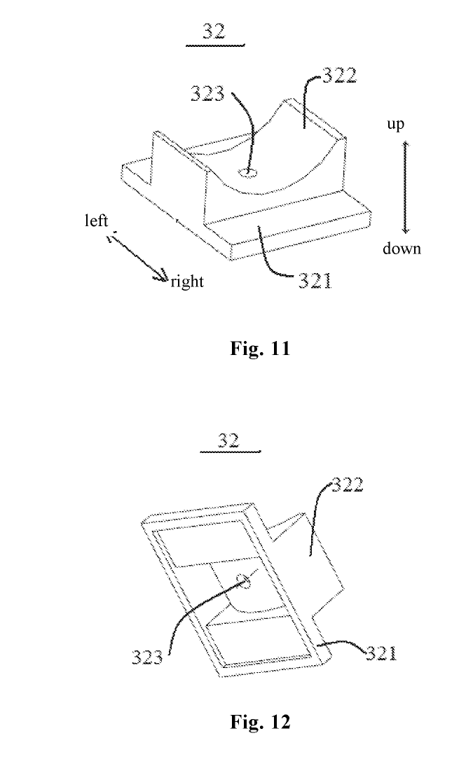

Advantageously, as shown in FIGS. 11 and 12, a ventilation hole 323 is formed in a surface of the second damper 32 abutting against the horizontal compressor 2, and runs through the second damper 32 to be in communication with exterior space. In such a way, the ventilation hole 323 may further enhance elasticity of the second damper 32, so as to improve the damping effect of the second damper 32, and the ventilation hole 323 may facilitate heat dissipation of the horizontal compressor 2, so as to avoid overheating of the horizontal compressor 2 and then guarantee the drying efficiency of the heat pump system 100.

Preferably, as shown in FIGS. 11 and 12, the second damper 32 may include a substrate 321 disposed in the base 1 and a supporting part 322 disposed on the substrate 321 and supporting the horizontal compressor 2, and the supporting part 322 has a size smaller than the substrate 321 in the axial direction (e.g. a left-and-right direction in FIG. 11) of the horizontal compressor 2. Thus, it is possible to enhance the stability of supporting the horizontal compressor 2 by the second damper 32 and make the structure of the second damper 32 more reasonable.

Preferably, as shown in FIG. 4, the second damper 32 supports a middle part of the horizontal compressor 2 along the axial direction (e.g. the left-and-right direction in FIG. 4) of the horizontal compressor 2, so as to further enhance the stability and reliability of supporting the horizontal compressor 2 by the second damper 32 and improve the damping effect on the horizontal compressor 2.

The heat pump system 100 according to a specific embodiment of the present invention will be described in detail with reference to FIGS. 1 to 12.

Referring to FIG. 1, the heat pump system 100 includes the base 1, the horizontal compressor 2 and the damper.

The damper includes two first dampers 31 and two second dampers 32; one first damper 31 is fitted over each of the two axial ends of the horizontal compressor 2, and two second damper 32 are provided at the top and the bottom of the horizontal compressor 2 respectively. Preferably, the first damper 31 and the second damper 32 are both configured as rubber members.

Specifically, as shown in FIGS. 5 to 10, the first damper 31 has an annular shape fitted over the outer circumferential surface of the horizontal compressor 2 and extending along the axial of the horizontal compressor 2; the first damper 31 is provided with the damping convex rib 311 that has a hollow elongated shape extending along the axial direction of the horizontal compressor 2, and the damping convex rib 311 has an inner end protruding inwards to abut against the outer circumferential surface of the horizontal compressor 2 and an outer end protruding outwards to abut against the base 1. Preferably, the plurality of spaced damping convex ribs 311 are provided and evenly or unevenly arranged in a direction surrounding the horizontal compressor 2.

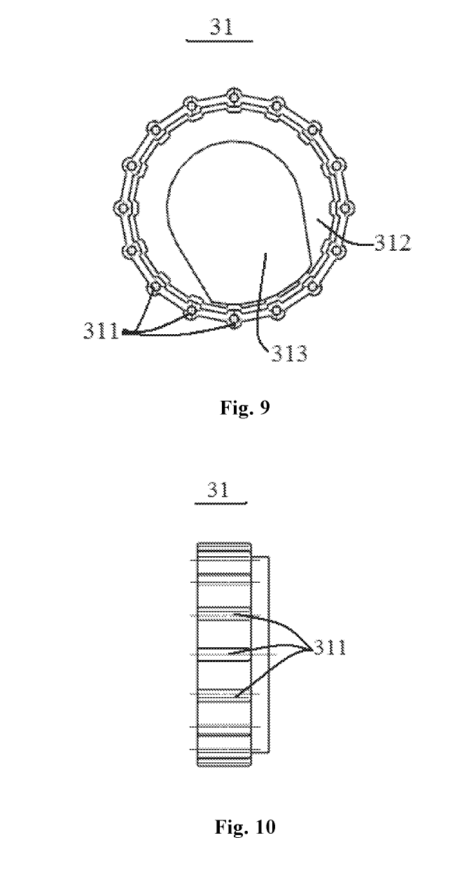

The first damper 31 further includes the end plate 312 in perpendicular to the axial of the horizontal compressor 2, and the end plate 312 abuts against left and right end faces of the horizontal compressor 2. The end plate 312 is formed with a processing hole 313 to facilitate connection between the horizontal compressor 2 and an external pipe, in which the processing hole 313 of the first damper 31 mounted at the left end of the horizontal compressor 2 is configured to be circular, while the processing hole 313 of the first damper 31 mounted at the right end thereof is configured to be substantially circular, as shown in FIG. 9.

The second damper 32 includes the substrate 321, and the supporting part 322 which is connected on the substrate 321 and extends along the axial direction of the horizontal compressor 2; moreover, the supporting part 322 has a size smaller than the substrate 321. Further, the supporting part 322 has an upper surface configured as an arc surface matching part of the outer surface of the horizontal compressor 2, and a lower surface configured as an arc surface parallel to the upper surface, so as to make up a hollow space below the supporting part 322 and then improve the damping effect of the second damper 32.

Preferably, the ventilation hole 323 is formed at a bottom of the supporting part 322 in a thickness direction (e.g. an up-and-down direction in FIG. 11) and runs through the supporting part 322 to be in communication with the exterior space.

Two second dampers 32 are provided at the top and the bottom of the horizontal compressor 2 respectively. The substrate 321 of the second damper 32 provided at the bottom of the horizontal compressor 2 is disposed on the base 1, and the supporting part 322 thereof is located on the substrate 321 to support the horizontal compressor 2; the substrate 321 of the second damper 32 provided at the top of the horizontal compressor 2 is disposed to a top cover 7, and the supporting part 322 thereof is located under the substrate 321 to separate the horizontal compressor 2 from the top cover 7.

During the working of the heat pump system 100, since the operation of the horizontal compressor 2 produces the high-frequency vibration, the vibration may be directly transmitted to other components through contact surfaces and hence negatively affect user experience and component service life, if no damping measure is adopted between the horizontal compressor 2 and the base 1.

In the heat pump system 100 according to this embodiment, the left and right ends of the horizontal compressor 2 are wrapped by the first dampers 31 that are made of rubber material and evenly provided with the damping convex ribs 311 along an annular direction, and the damping convex rib 311 is configured to be hollow. Meanwhile, the top and the bottom of the horizontal compressor 2 both adopt the second damper 32 that has a semi-circular or concave surface in contact with the outer surface of the horizontal compressor 2, so as to bear a cylinder body of the horizontal compressor 2 and reduce the vibration.

In the heat pump system 100 according to this embodiment, the horizontal compressor 2 is wrapped by the combination of the first damper 31 and the second damper 32, so as to reduce and absorb the vibration of the horizontal compressor 2 effectively.

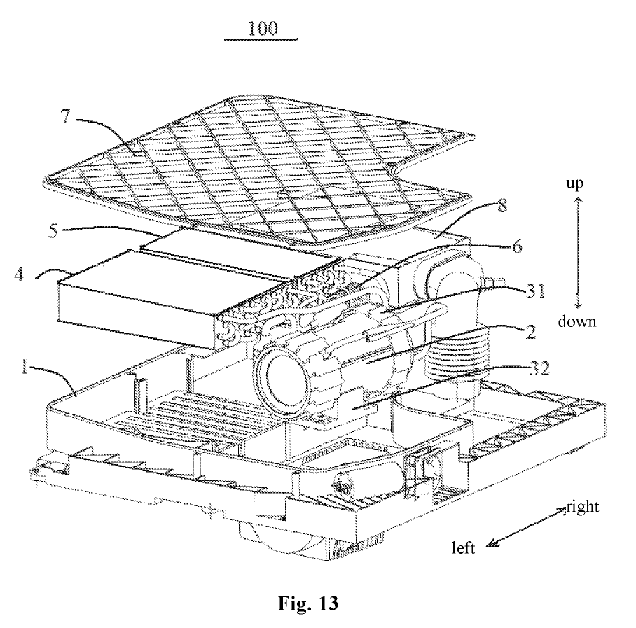

In addition, as shown in FIG. 13, the heat pump system 100 according to this embodiment at least further includes an evaporator 5, a condenser 4, a throttling device 6, a fan, an air passage, the top cover 7 and a filtering device 8, in which the horizontal compressor 2, the evaporator 5, the condenser 4, the throttling device 6, the fan, the air passage, and the filtering device 8 are disposed in the base 1, and the top cover 7 is disposed on the base 1 and covers it.

The heat pump system 100 according to this embodiment may realize componentization, modularization and integration, and the integrated heat pump system 100 may be mounted at the top of a drum-type washing machine assembly to realize modularized production and installation.

The drier or washer-drier according to embodiments of a second aspect of the present invention includes the heat pump system 100 according to the first aspect of the present invention.

The overall performance of the drier or washer-drier according to the present invention may be improved by providing the heat pump system 100 according to the first aspect.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” should be construed to refer to the orientation as then described or as shown in the drawings under discussion. These relative terms are for convenience of description and do not require that the present invention be constructed or operated in a particular orientation.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

In the present invention, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the present invention, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout this specification to “an embodiment,” “some embodiments,” “an example,” “specific examples,” or “some examples” means that a particular feature, structure, material, or characteristic described in connection with the embodiment or example is included in at least one embodiment or example of the present invention. Thus, the appearances of the above phrases throughout this specification are not necessarily referring to the same embodiment or example of the present invention. Furthermore, the particular features, structures, materials, or characteristics may be combined in any suitable manner in one or more embodiments or examples. Those skilled in the art can integrate and combine different embodiments or examples and the features in different embodiments or examples in the specification.

Although embodiments of the present invention have been shown and illustrated, it shall be understood by those skilled in the art that various changes, modifications, alternatives and variants without departing from the principle and spirit of the present invention are acceptable. The scope of the present invention is defined by the claims or the like.

What is claimed is:

1. A heat pump system, comprising:
a base;
a horizontal compressor mounted to the base; and
a damper supported on the base and supporting the horizontal compressor, at least two dampers being arranged along an axial direction of the horizontal compressor.

2. The heat pump system according to claim 1, wherein the damper comprises a first damper provided with a damping convex rib abutting against the base and the horizontal compressor, and the first damper is provided with one damping convex rib or a plurality of spaced damping convex ribs.

3. The heat pump system according to claim 2, wherein the damping convex rib has a hollow or solid elongated shape extending along the axial direction of the horizontal compressor, and the plurality of spaced damping convex ribs are arranged in a direction surrounding the horizontal compressor.

4. The heat pump system according to claim 1, wherein the first damper fitted over an outer circumferential surface of the horizontal compressor has an annular shape, and extends along the axial direction of the horizontal compressor.

5. The heat pump system according to claim 4, wherein the first damper further comprises an end plate in perpendicular to the axial of the horizontal compressor, and the end plate abuts against an end face of the horizontal compressor.

6. The heat pump system according to claim 4, wherein two first dampers are provided and fitted over two ends of the horizontal compressor respectively.

7. The heat pump system according to claim 1, wherein the damper comprises a second damper disposed to the base and supporting a bottom of the horizontal compressor, and the second damper has a hollow or solid structure, and an upper surface configured as an arc surface matching part of an outer surface of the horizontal compressor.

8. The heat pump system according to claim 7, wherein a ventilation hole is formed in a surface of the second damper abutting against the horizontal compressor, and runs through the second damper to be in communication with exterior space.

9. The heat pump system according to claim 8, wherein the second damper comprises a substrate and a supporting part, the substrate is disposed to the base, the supporting part is disposed on the substrate and supports the horizontal compressor, and the supporting part has a size smaller than the substrate in the axial direction of the horizontal compressor.

10. The heat pump system according to claim 7, wherein the second damper supports a middle part of the horizontal compressor along the axial direction of the horizontal compressor.

11. A drier or washer-drier, comprising a heat pump system comprising:
a base;
a horizontal compressor mounted to the base; and
a damper supported on the base and supporting the horizontal compressor, at least two dampers being arranged along an axial direction of the horizontal compressor.

12. The drier or washer-drier according to claim 11, wherein the damper comprises a first damper provided with a damping convex rib abutting against the base and the horizontal compressor, and the first damper is provided with one damping convex rib or a plurality of spaced damping convex ribs.

13. The drier or washer-drier according to claim 12, wherein the damping convex rib has a hollow or solid elongated shape extending along the axial direction of the horizontal compressor, and the plurality of spaced damping convex ribs are arranged in a direction surrounding the horizontal compressor.

14. The drier or washer-drier according to claim 11, wherein the first damper fitted over an outer circumferential surface of the horizontal compressor has an annular shape, and extends along the axial direction of the horizontal compressor.

15. The drier or washer-drier according to claim 14, wherein the first damper further comprises an end plate in perpendicular to the axial of the horizontal compressor, and the end plate abuts against an end face of the horizontal compressor.

16. The drier or washer-drier according to claim 14, wherein two first dampers are provided and fitted over two ends of the horizontal compressor respectively.

17. The drier or washer-drier according to claim 11, wherein the damper comprises a second damper disposed to the base and supporting a bottom of the horizontal compressor, and the second damper has a hollow or solid structure, and an upper surface configured as an arc surface matching part of an outer surface of the horizontal compressor.

18. The drier or washer-drier according to claim 17, wherein a ventilation hole is formed in a surface of the second damper abutting against the horizontal compressor, and runs through the second damper to be in communication with exterior space.

19. The drier or washer-drier according to claim 18, wherein the second damper comprises a substrate and a supporting part, the substrate is disposed to the base, the supporting part is disposed on the substrate and supports the horizontal compressor, and the supporting part has a size smaller than the substrate in the axial direction of the horizontal compressor.

20. The drier or washer-drier according to claim 17, wherein the second damper supports a middle part of the horizontal compressor along the axial direction of the horizontal compressor.
